(19) United States
(12) Patent Application Publication
(10) Pub. No.: US 2014/0023373 A1
(43) Pub. Date: Jan. 23, 2014

(54) OPTICAL SIGNAL DROPPER AND OPTICAL SIGNAL ADDER FOR USE IN A ROADM SYSTEM

(71) Applicant: NEC CORPORATION, Tokyo (JP)

(72) Inventor: Akihiro TOSAKI, Tokyo (JP)

(21) Appl. No.: 13/917,127

(22) Filed: Jun. 13, 2013

(30) Foreign Application Priority Data
Jul. 17, 2012 (JP) 2012-158500

(51) Int. Cl. H04J 14/02

(52) U.S. Cl. CPC H04J 14/0204
USPC 398/83

(57) ABSTRACT

A plurality of output units 31, each having first output ports and second output ports, output received input wavelength-specific optical signals from the output ports. Switchers 32 output the wavelength-specific optical signals output from the first output ports of the output units 31 to respective different optical paths. Output units 31 correspond respectively to a plurality of routes for transmitting wavelength-multiplexed optical signals. Each of output units 31 receives a wavelength-specific optical signal included in the wavelength-multiplexed optical signal transmitted through a corresponding route and wavelength-specific optical signals output from the second output ports of other output units, as the input wavelength-specific optical signals, and output each of the wavelength-specific optical signals from either the first output ports or the second output ports depending on the wavelength of the wavelength-specific optical signal.

This application is based upon and claims the benefit of priority from Japanese Patent Application No. 2012-158500 filed on Jul. 17, 2012, the content of which is incorporated by reference.

### BACKGROUND OF THE INVENTION

1. Field of the Invention

The present invention relates to an optical signal dropper and an optical signal adder.

2. Description of the Related Art

In the field of optical communications, there has been known a wavelength division multiplexing (WDM) technology for transmitting a wavelength-multiplexed optical signal that is generated by multiplexing optical signals having respective wavelengths (hereinafter referred to as “wavelength-specific optical signals”) that are assigned to the links between client devices. When wavelength-specific optical signals are multiplexed according to the WDM technology, it is possible to realize high-speed, large-capacity transmission links.

Known communication systems based on the WDM technology include a ROADM (Reconfigurable Optical Add/Drop Multiplexer) system. The ROADM system includes a plurality of ROADM nodes connected into a ring-shaped configuration by optical fibers, each of the ROADM nodes being capable of adding a wavelength-specific optical signal to a wavelength-multiplexed optical signal and dropping a wavelength-specific optical signal from a wavelength-multiplexed optical signal. Client devices are connected to the ROADM nodes by transponders which serve as relay interfaces. The ROADM system sets a ROADM node to the wavelengths of wavelength-specific optical signals to be added to wavelength-multiplexed optical signals by the ROADM node and the wavelengths of wavelength-specific optical signals to be dropped from wavelength-multiplexed optical signals by the ROADM node, thereby constructing an optical path as a virtual transmission link between client devices. The client devices that are connected to the ROADM node can then transmit information through the optical path.

The ROADM system is also able to open and eliminate the optical path by remotely controlling the ROADM node. Therefore, the amount of field work involved in opening and eliminating the optical path is greatly reduced, allowing the ROADM system to operate highly efficiently and flexibly.

Next-generation ROADM systems which need to operate highly efficiently and flexibly will be required to have the following three functions: The first function is a colorless function that allows a transponder to use any one of all wavelengths used in the ROADM system as the wavelength of a wavelength-specific optical signal that is input to and output from the transponder, regardless of the port of a ROADM node to which the transponder is connected.

The second function is a directionless function that allows a transponder to add a wavelength-specific optical signal to all wavelength-multiplexed optical signals transmitted through all routes connected to the ROADM system, and also to drop a wavelength-specific optical signal from all wavelength-multiplexed optical signals transmitted through all routes, regardless of the port of a ROADM node to which the transponder is connected.

The third function is a contentionless function that allows a ROADM system having such a connectionless function, even if it uses wavelength-specific optical signals having a common wavelength that are transmitted through a plurality of routes connected to a ROADM node, to input the wavelength-specific optical signals to and output the wavelength-specific optical signals from a transponder without causing a conflict which would otherwise mix the wavelength-specific optical signals with each other.

FIG. 1 of the accompanying drawings shows by way of example the configuration of a ROADM node with a colorless function and a directionless function according to the related art. ROADM node 90 shown in FIG. 1 has optical cross-connect 100 and optical dropper/adder 900. Optical dropper/adder 900 has optical dropper 700 and optical adder 800. Each of optical dropper 700 and optical adder 800 has two opposite wavelength selective switches (WSS), i.e., first WSS 71 and second WSS 72. When wavelength-specific optical signals having common wavelength λ1 are input to a plurality of input ports of first WSS 71 of optical dropper 700, first WSS 71 is able to output only the wavelength-specific optical signal from one of the input ports. The ROADM node is unable to perform its contentionless function due to a conflict between the wavelength-specific optical signals supplied to the input ports.

Document 1 (JP2012-60622A) discloses an optical signal terminator which realizes the CDC functions, i.e., the colorless, directionless, and contentionless functions. The disclosed optical signal terminator has an optical coupler for dropping as many wavelength-multiplexed optical signals as the number of transponders from a wavelength-multiplexed optical signal, a plurality of optical switches corresponding respectively to the transponders, for selecting a wavelength-multiplexed optical signal including a wavelength-specific optical signal having a desired wavelength from the wavelength-multiplexed optical signals dropped by the optical coupler, and a tunable variable filter for outputting the wavelength-specific optical signal having the desired wavelength from the wavelength-multiplexed optical signal selected by the optical switches.

The optical signal terminator disclosed in Document 1 does not take into account connecting a new transponder to a ROADM node, and hence is of low scalability because its device configuration has to be greatly modified if a new transponder is to be connected.

Specifically, the optical signal terminator is of low scalability since it needs to have an optical coupler for dropping as many wavelength-multiplexed optical signals as the number of transponders, and to modify or add optical couplers, optical switches, and tunable variable filters according to the number of dropped wavelength-multiplexed optical signals. It is difficult to add a plurality of components to expand the optical signal terminator from the standpoints of the ease of wiring and the size of the device housing.

### SUMMARY OF THE INVENTION

It is an object of the present invention to provide an optical signal dropper and an optical signal adder which are of high scalability and capable of realizing a ROADM system having CDC functions.

According to the present invention, there is provided an optical signal dropper comprises a plurality of drop wavelength selection/input units, each having a first output port and a second output port, for outputting received input wavelength-specific optical signals from the output ports, and a drop output unit for outputting wavelength-specific optical signals output from the first output ports of the drop wavelength selection/input units, to respective different optical paths, wherein the drop wavelength selection/input units correspond respectively to a plurality of routes for transmitting wavelength-multiplexed optical signals, and each of the drop wavelength selection/input units receives a wavelength-specific optical signal included in the wavelength-multiplexed optical signal transmitted through a corresponding route and wavelength-specific optical signals output from the second output ports of other drop wavelength selection/input units, as the input wavelength-specific optical signals, and outputs each of the wavelength-specific optical signals from either one of the first output port or the second output port depending on the wavelength of the wavelength-specific optical signal.

According to the present invention, there is also provided an optical signal adder comprising a plurality of add wavelength selection/output units which correspond respectively to a plurality of routes for transmitting wavelength-multiplexed optical signals, each of the add wavelength selection/output units having a third output port connected to a corresponding one of the routes and a fourth output port, wherein each of the add wavelength selection/output units outputs received input wavelength-specific optical signals from the output ports, and an add input unit for receiving wavelength-specific optical signals from a plurality of optical paths and outputting the received wavelength-specific optical signals respectively to the add wavelength selection/output units, wherein each of the add wavelength selection/output units receives the wavelength-specific optical signals output from the add input unit and the wavelength-specific optical signals output from the fourth output ports of other add wavelength selection/output units, as the input wavelength-specific optical signals, and outputs each of the wavelength-specific optical signals from either the third output port or the fourth output port depending on the wavelength of the wavelength-specific optical signal.

According to the present invention, it is possible to realize a ROADM system which is of high scalability and which has CDC functions.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a block diagram showing by way of example the configuration of a ROADM node with a colorless function and a directionless function according to the related art.

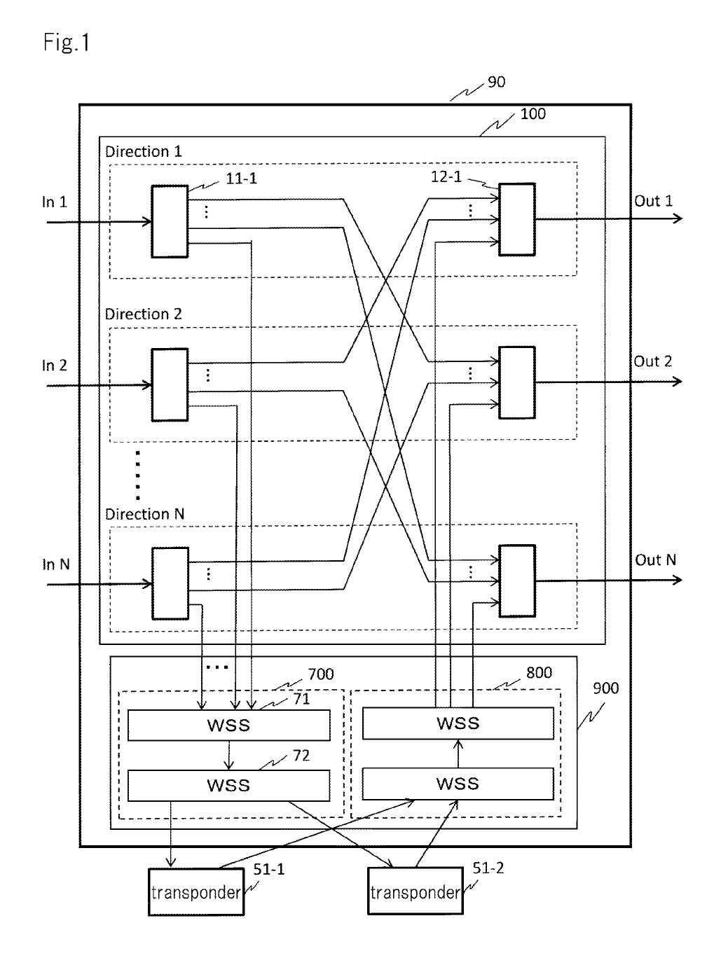

FIG. 2 is a block diagram showing the configuration of a ROADM node according to an exemplary embodiment of the present invention;

FIG. 3 is a block diagram showing the detailed configuration of an optical dropper of the ROADM node according to the exemplary embodiment;

FIG. 4 is a block diagram showing the detailed configuration of an optical adder of the ROADM node according to the exemplary embodiment;

FIG. 5 is a block diagram showing the configuration of a ROADM system wherein two ROADM nodes according to the exemplary embodiment are connected to each other by three routes;

FIG. 6 is a block diagram showing a situation in which a fault has occurred in the ROADM system according to the exemplary embodiment;

FIG. 7 is a block diagram showing an example of operation of the ROADM system according to the exemplary embodiment after the occurrence of the fault;

FIG. 8 is a block diagram showing the detailed configuration of the optical dropper of the ROADM node according to the exemplary embodiment which is connected to the three routes;

FIG. 9 is a block diagram showing a state of the optical dropper before a fault occurs in the ROADM system according to the exemplary embodiment;

FIG. 10 is a block diagram showing a state of the optical dropper when a fault has occurred in the ROADM system according to the exemplary embodiment;

FIG. 11 is a block diagram showing an example of operation of the ROADM system according to the exemplary embodiment after the occurrence of the fault; and

### DETAILED DESCRIPTION OF THE EMBODIMENTS

An optical signal dropper and an optical signal adder according to an exemplary embodiment of the present invention will be described below with reference to the accompanying drawings. In the description and drawings, components having identical functions are denoted by identical reference characters throughout the views, and redundant description thereof may be omitted hereinbelow.

In the description and drawings, some components having identical functions are denoted by identical reference characters hyphenated with different numerals as suffixes. For example, a plurality of components having identical functions are distinguished as dropping matrix switch 32-1 and dropping matrix switch 32-2, if it is necessary to distinguish components that have identical functions. If a plurality of components having identical functions do not need to be distinguished, then they are denoted by identical reference characters. For example, if dropping matrix switch 32-1 and dropping matrix switch 32-2 do not need to be distinguished, then they are referred to simply as dropping matrix switches 32.

In the description, of optical signals that are transmitted by a ROADM node, optical signals having particular wavelengths are referred to as wavelength-specific optical signals. Optical signals which are multiplexed wavelength-specific optical signals are referred to as wavelength-multiplexed optical signals. If there is no need to distinguish wavelength-specific optical signals and wavelength-multiplexed optical signals from each other, they are simply referred to as optical signals.

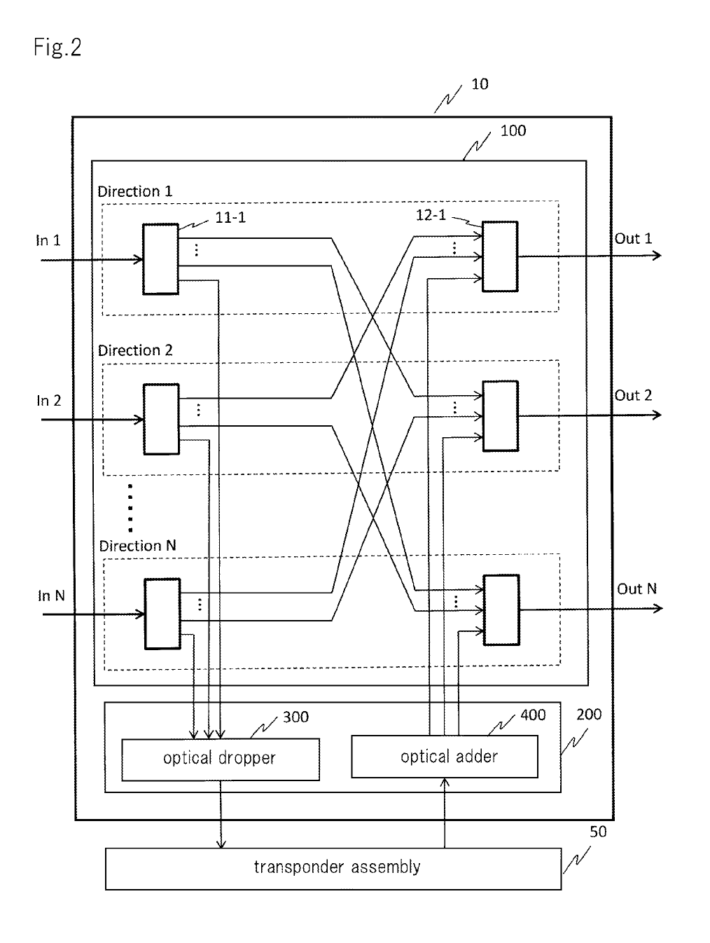

The configuration of a ROADM node according to an exemplary embodiment of the present invention will be described below. FIG. 2 shows in block form the configuration of a ROADM node according to an exemplary embodiment of the present invention. ROADM node 10 shown in FIG. 2 has optical cross connect 100 and optical dropper/adder 200. ROADM node 10 is connected to a network management system (hereinafter referred to as NMS), not shown, and operates according to commands from the NMS.

Optical cross connect 100 includes N (N refers to an integer of 2 or greater) demultiplexers 11 corresponding respectively to N routes which input wavelength-multiplexed optical signals to RAODM node 10, and N multiplexers 12 corresponding respectively to N routes which output wavelength-multiplexed optical signals from RAODM node 10. Optical dropper/adder 200 has optical dropper 300 and optical adder 400.

Demultiplexers 11 demultiplex wavelength-multiplexed optical signals that are input from the corresponding routes, and input demultiplexed optical signals to optical dropper 300 and multiplexers 12.

Multiplexers 12 multiplex optical signals input from demultiplexers 11 and optical adder 400, and output wavelength-multiplexed optical signals, which represent the multiplexed optical signals, from the corresponding routes.

Optical dropper 300 drops the optical signals input from respective multiplexers 12 and passes them to respective transponders included in transponder assembly 50. Transponder assembly 50 has a plurality of transponders each connected to both optical dropper 300 and optical adder 400. Optical dropper 300 inputs wavelength-specific optical signals to different transponders depending on the wavelengths of the wavelength-specific optical signals included in the wavelength-multiplexed optical signals.

Optical adder 400 generates wavelength-multiplexed optical signals by multiplexing wavelength-specific optical signals input from the transponders, and input the wavelength-multiplexed optical signals to multiplexers 12. Optical adder 400 inputs optical signals to multiplexers 12 which correspond to the routes determined depending on the wavelengths of the input wavelength-specific optical signals.

ROADM node 10 of the above configuration drops wavelength-multiplexed optical signals In1 through InN input from the respective routes into wavelength-specific optical signals to be output to the respective transponders, and adds wavelength-specific optical signals input from the respective transponders to wavelength-multiplexed optical signals to be transmitted through the respective routes.

When a client device is to transmit information to another client device through the ROADM system, the NMS sets the wavelength of a wavelength-specific optical signal to be added to transmit the information, so that source ROADM node 10, to which the source client device for transmitting the information is connected, will add the wavelength-specific optical signal to a wavelength-multiplexed optical signal that is to be transmitted through a route to destination ROADM node 10 to which the destination client device for receiving the information is connected. At this time, the NMS also sets the wavelength of a wavelength-specific optical signal to be dropped at destination ROADM node 10, so that destination ROADM node 10 will drop the wavelength-specific optical signal for transmitting the information and input the dropped wavelength-specific optical signal to a transponder to which the destination client device is connected. The ROADM system is thus capable of configuring an optical path as a virtual transmission link between the source client device and the destination client device.

Details of the configuration of optical dropper 300 of ROADM node 10 according to the present exemplary embodiment will be described below.

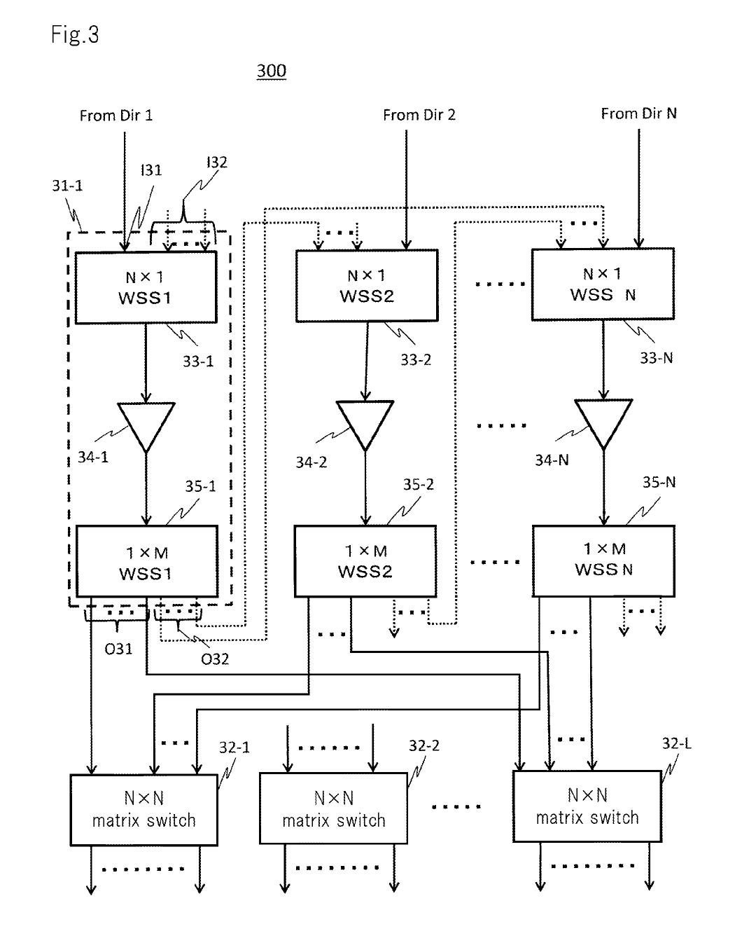

FIG. 3 shows in block form the detailed configuration of optical dropper 300 of ROADM node 10 according to the exemplary embodiment. As shown in FIG. 3, optical dropper 300 has N drop wavelength selection/input units 31 corresponding to respective routes, and L drop matrix switches 32 serving as switchers for outputting wavelength-specific optical signals output from respective drop wavelength selection/input units 31 to different optical paths.

Each of drop wavelength selection/input units 31 has first output ports for outputting wavelength-specific optical signals to drop matrix switches 32 and second output ports for outputting wavelength-specific optical signals to other drop wavelength selection/input units 31. Each of drop wavelength selection/input units 31 receives a wavelength-specific optical signal which is included in the wavelength-multiplexed optical signal transmitted through the corresponding route and which is dropped by demultiplexer 11 and input to drop wavelength selection/input unit 31 and optical signals output from other drop wavelength selection/input units 31, as input wavelength-specific optical signals, and outputs each of the wavelength-specific optical signals from either the first output ports or the second output ports based on the wavelength of the wavelength-specific optical signal.

Specifically, each of drop wavelength selection/input units 31 has first WSS 33, optical amplifier 34, and second WSS 35. In FIG. 3, only first drop wavelength selection/input unit 31-1 corresponding to the first route is illustrated. However, the other drop wavelength selection/input units corresponding to the second through Nth routes are similarly denoted. For example, first WSS 33-2, optical amplifier 34-2, and second WSS 35-2 are collectively referred to as second drop wavelength selection/input unit 31-2, and first WSS 33-N, optical amplifier 34-N, and second WSS 35-N are collectively referred to as Nth drop wavelength selection/input unit 31-N.

First WSS 33 and second WSS 35 are devices which are capable of passing, blocking, and level-adjusting wavelength-specific optical signals that are input to respective input ports thereof, and of selecting output ports by adjusting the directions of internal optical switches. First WSS 33 and second WSS 35 operate according to commands from the NMS. First WSS 33 and second WSS 35 pass, block, and level-adjust wavelength-specific optical signals depending on the wavelengths thereof.

First WSS 33 has N input ports and a single output port. The N input ports include first input port 131 connected to the corresponding route and (N−1) second input ports I32 connected to other drop wavelength selection/input units 31. First WSS 33 receives, through these input ports, a wavelength-specific optical signal which is included in the wavelength-multiplexed optical signal transmitted through the corresponding route and optical signals output from other drop wavelength selection/input units 31, and selectively passes a wavelength-specific optical signal having a preset wavelength to optical amplifier 34.

Optical amplifier 34 is a device which amplifies an optical signal input thereto, rather than an electric signal converted therefrom. Optical amplifier 34 comprises a laser amplifier, for example. Optical amplifier 34 may alternatively comprise an optical fiber amplifier or a semiconductor optical amplifier (SOA). Optical amplifier 34 amplifies an optical signal input from first WSS 33 and inputs the amplified optical signal to second WSS 35.

Second WSS 35 has a single input port and M (M refers to an integer of 2 or greater) output ports. The M output ports include first output ports O31 connected to respective drop matrix switches 32 and second output ports O32 connected to respective input ports of other drop wavelength selection/input units 31. Second WSS 35 outputs each of wavelength-specific optical signals included in an optical signal input from optical amplifier 34 to either first output ports O31 or second output ports O32 based on the wavelength of the wavelength-specific optical signal.

Each of drop matrix switches 32 is a switch for connecting N input ports and M output ports in a combination set by the NMS. Specifically, each of drop matrix switches 32 has N input ports connected to first output ports of respective drop wavelength selection/input units 31 and N output ports connected to receivers of the respective transponders. As described above, there are L drop matrix switches 32 where L refers to an integer of 2 or greater. Each of drop matrix switches 32 is connected to first output ports of respective drop wavelength selection/input units 31.

Details of the configuration of optical adder 400 of ROADM node 10 according to the present exemplary embodiment will be described below.

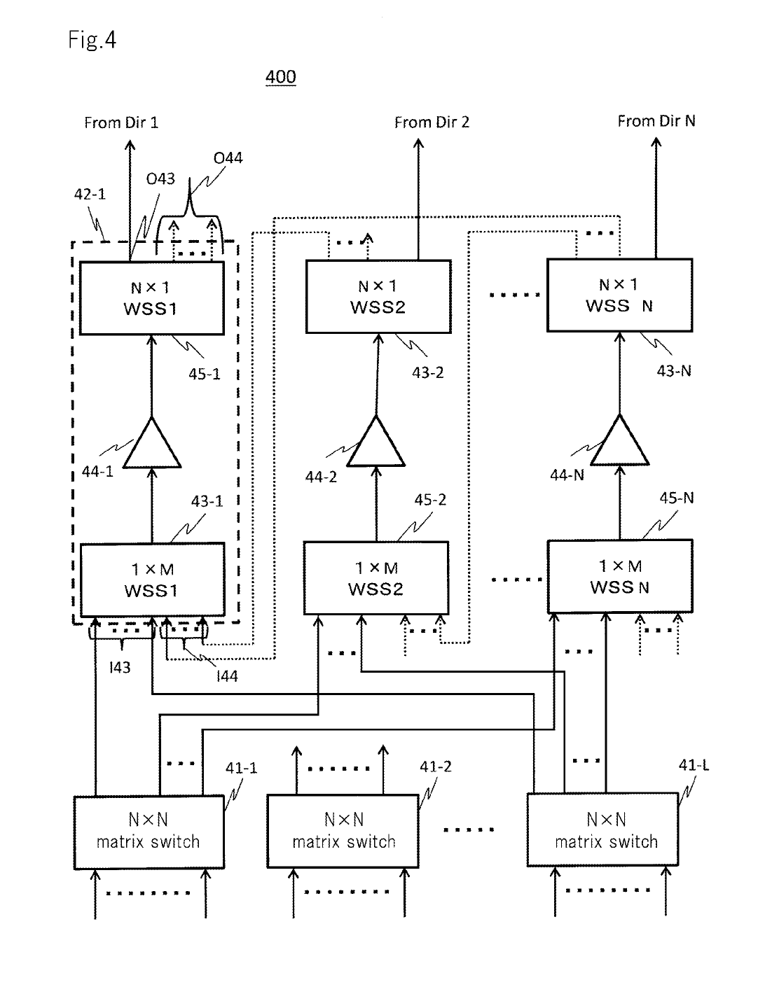

FIG. 4 shows in block form the detailed configuration of optical adder 400 of ROADM node 10 according to the exemplary embodiment. As shown in FIG. 4, optical adder 400 has L add matrix switches 41 that serve as switchers for selectively inputting wavelength-specific optical signals from a plurality of optical paths to a plurality of add wavelength selection/output units 42 corresponding to respective routes.

Each of add matrix switches 41 is a switch for connecting N input ports and N output ports in a combination set by the NMS. Specifically, each of add matrix switches 41 has N input ports connected to the transponders of transponder assembly 50 and N output ports connected to input ports of respective add wavelength selection/output units 42. As described above, there are L add matrix switches 41 where L refers to an integer of 2 or greater. If L is 2 or greater, then each of add matrix switches 41 is connected to input ports of respective N add wavelength selection/output units 42.

Each of add wavelength selection/output units 42 has a third output port connected to the corresponding route and fourth output ports connected to other add wavelength selection/output units 42. Each of add wavelength selection/output units 42 receives wavelength-specific optical signals which are input from respective add matrix switches 41 and optical signals which are input from other add wavelength selection/output units 42, as input wavelength-specific optical signals, and outputs each of the wavelength-specific optical signals from either one of third output ports 43 or fourth output ports 44 based on the wavelength of the wavelength-specific optical signal.

Specifically, each of add wavelength selection/output units 42 has third WSS 43, optical amplifier 44, and fourth WSS 45. In FIG. 4, only first add wavelength selection/input unit 42-1 that corresponds to the first route is illustrated. However, the other add wavelength selection/input units that corresponds to the second through Nth routes are similarly denoted. For example, third WSS 43-2, optical amplifier 44-2, and fourth WSS 45-2 are collectively referred to as second add wavelength selection/input unit 42-2, and third WSS 43-N, optical amplifier 44-N, and fourth WSS 45-N are collectively referred to as Nth add wavelength selection/input unit 42-N.

Third WSS 43 and fourth WSS 45 are devices which are capable of passing, blocking, and level-adjusting wavelength-specific optical signals that are input to respective input ports thereof, and of selecting output ports by adjusting the directions of internal optical switches. Third WSS 43 and fourth WSS 45 operate according to commands from the NMS. Third WSS 43 and fourth WSS 45 pass, block, and level-adjust wavelength-specific optical signals depending on the wavelengths thereof.

Third WSS 43 has M input ports and a single output port. The M input ports include third input port I43 connected to respective add matrix switches 41 and fourth input ports I44 connected to other add wavelength selection/output units 42. Third WSS 43 receives, through these input ports, wavelength-specific optical signals which are input from respective add matrix switches 41 and optical signals output from other add wavelength selection/output units 42, and selectively passes a wavelength-specific optical signal having a preset wavelength to optical amplifier 44.

Optical amplifier 44 is a device which amplifies an optical signal input thereto, rather than an electric signal converted therefrom. Optical amplifier 44 comprises a laser amplifier, for example. Optical amplifier 44 may alternatively comprise an optical fiber amplifier or a semiconductor optical amplifier (SOA). Optical amplifier 44 amplifies an optical signal input from third WSS 43 and inputs the amplified optical signal to fourth WSS 45.

Fourth WSS 45 has a single input port and N output ports. The N output ports include third output ports O43 connected to the respective routes and fourth output ports O44 connected to respective input ports of other add wavelength selection/output units 42. Fourth WSS 45 outputs each of wavelength-specific optical signals included in an optical signal input from optical amplifier 44 to either third output ports O43 or fourth output ports O44 based on the wavelength of the wavelength-specific optical signal.

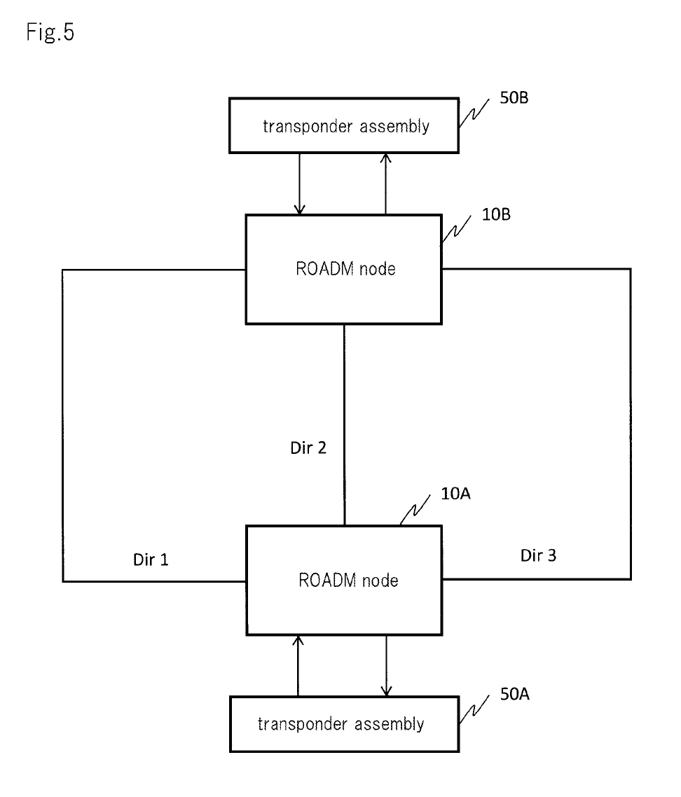

Operation of ROADM node 10 in the case in which a fault occurs in the ROADM system according to the present exemplary embodiment will be described below. FIG. 5 shows in block form the configuration of a ROADM system wherein two ROADM nodes according to the exemplary embodiment are connected to each other by three routes.

In FIG. 5, ROADM node 10A having three routes will be described below by way of example for the sake of brevity. The ROADM system has ROADM nodes 10A, 10B which are connected to each other by three routes Dir1 through Dir3. ROADM node 10A is connected to transponder assembly 50A, and ROADM node 10B is connected to transponder assembly 50B.

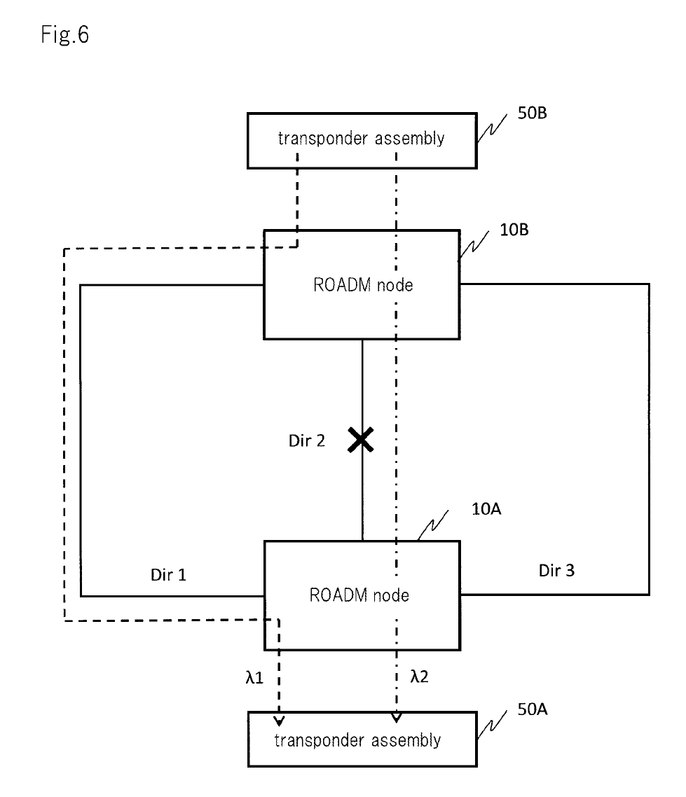

FIG. 6 shows in block form a situation in which a fault has occurred in the ROADM system according to the present exemplary embodiment. Normally, while no fault is occurring in the ROADM system, ROADM node 10B transmits, from among the wavelength-specific optical signals input from transponder assembly 50B, a wavelength-specific optical signal having wavelength λ1 through route Dir1 to ROADM NODE 10A, and also transmits a wavelength-specific optical signal having wavelength λ2 through route Dir2 to ROADM NODE 10A. An example of the operation of the ROADM system in case in which a fault occurs in route Dir2 will be described below.

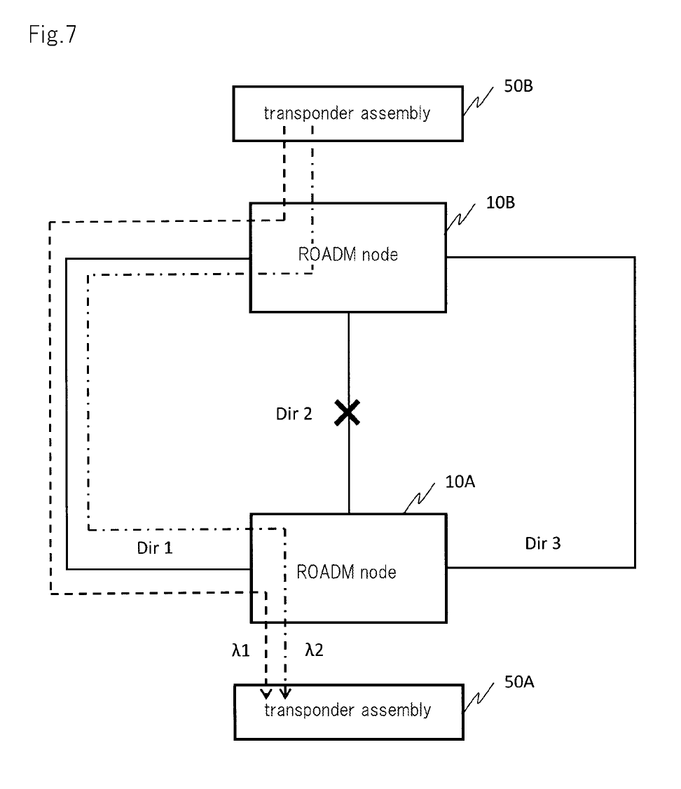

FIG. 7 shows in block form an example of operation of the ROADM system according to the present exemplary embodiment after the occurrence of the fault in the ROADM system.

In the case in which route Dir2 cannot work because of the fault, the NMS, which has detected the fault, changes settings to cause ROADM node 10B to output the wavelength-specific optical signal that has wavelength λ2 to route Dir1. ROADM node 10A is now supplied with a wavelength-multiplexed optical signal including wavelength-specific optical signals that have wavelengths λ1, λ2 from route Dir1.

Details of the configuration of optical dropper 300 of ROADM node 10A will be described below.

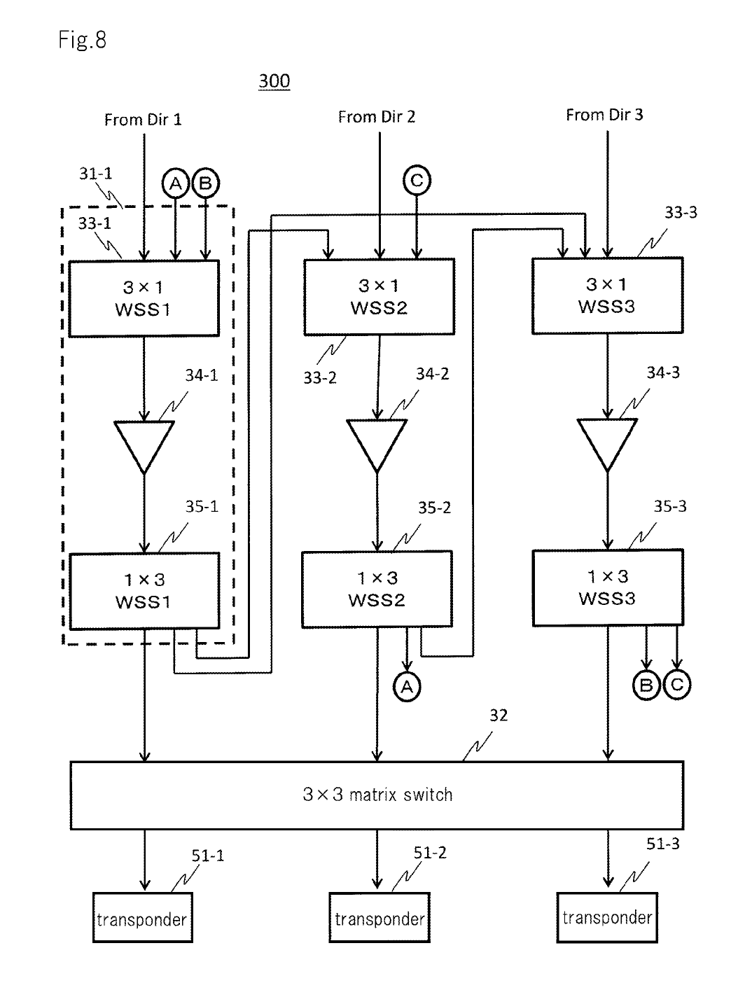

FIG. 8 shows in block form the detailed configuration of an optical dropper of the ROADM node according to the present exemplary embodiment which is connected to three routes.

As shown in FIG. 8, optical dropper 300 includes first drop wavelength selection/input unit 31-1 corresponding to route Dir1, second drop wavelength selection/input unit 31-2 corresponding to route Dir2, third drop wavelength selection/input unit 31-3 corresponding to route Dir3, and single drop matrix switch 32. Each drop wavelength selection/input unit 31 has first WSS 33, optical amplifier 34, and second WSS 35.

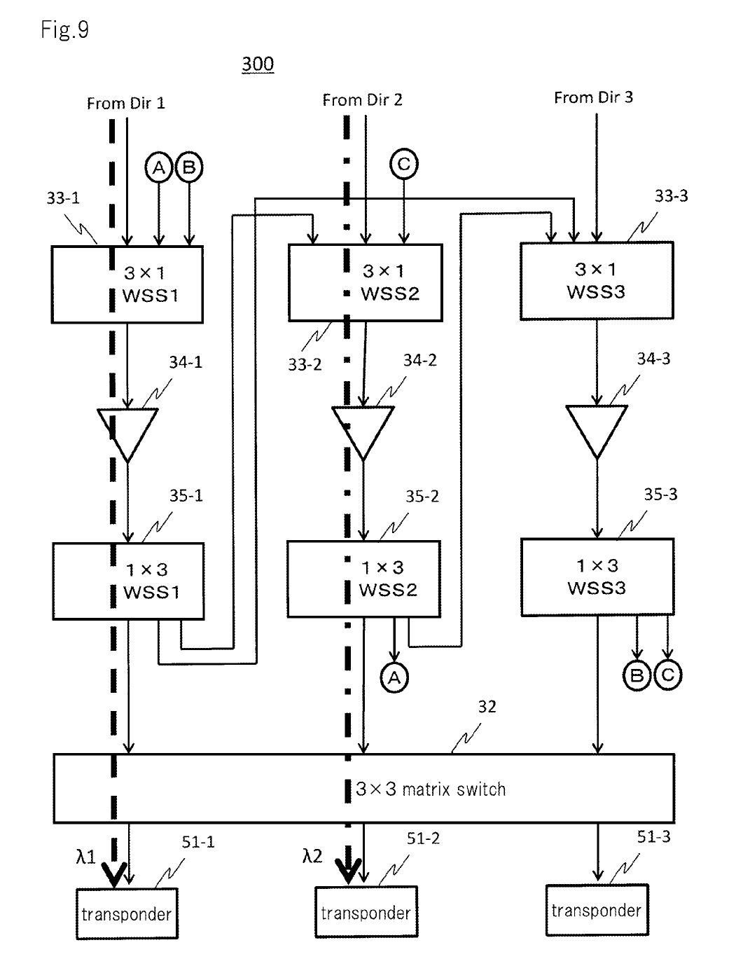

Normally, before a fault occurs in the ROADM system, ROADM node 10A is supplied with a wavelength-multiplexed optical signal including a wavelength-specific optical signal having wavelength λ1 from route Dir1, and also with a wavelength-multiplexed optical signal including a wavelength-specific optical signal having wavelength λ2 from route Dir2. FIG. 9 shows in block form a state of the optical dropper before a fault occurs in the ROADM system according to the present exemplary embodiment.

Normally, prior to the occurrence of a fault, the NMS has settings for demultiplexer 11-1 to input a wavelength-specific optical signal having wavelength λ1 to optical dropper 300 and for demultiplexer 11-2 to input a wavelength-specific optical signal having wavelength λ2 to optical dropper 300.

Therefore, when supplied with the wavelength-multiplexed optical signal including the wavelength-specific optical signal having wavelength λ1 from route Dir1, demultiplexer 11-1 demultiplexes the supplied wavelength-multiplexed optical signal and inputs the wavelength-specific optical signal having wavelength λ1 to first drop wavelength selection/input unit 31-1 of optical dropper 300. Similarly, when supplied with the wavelength-multiplexed optical signal including the wavelength-specific optical signal having wavelength λ2 from route Dir2, demultiplexer 11-2 demultiplexes the supplied wavelength-multiplexed optical signal and inputs the wavelength-specific optical signal having wavelength λ2 to second drop wavelength selection/input unit 31-2 of optical dropper 300.

The NMS also has settings for first drop wavelength selection/input unit 31-1 to pass the wavelength-specific optical signal having wavelength λ1 to drop matrix switch 32. Similarly, the NMS has settings for second drop wavelength selection/input unit 31-2 to pass the wavelength-specific optical signal having wavelength λ2 to drop matrix switch 32. The NMS also has settings for drop matrix switch 32 to interconnect its input port connected to first drop wavelength selection/input unit 31-1 and its output port connected to first transponder 51-1, to interconnect its input port connected to second drop wavelength selection/input unit 31-2 and its output port connected to second transponder 51-2, and to interconnect its input port connected to third drop wavelength selection/input unit 31-3 and its output port connected to third transponder 51-3.

Consequently, first WSS 33-1 passes an optical signal including at least the wavelength-specific optical signal having wavelength λ1, from among the wavelength-multiplexed optical signal including the wavelength-specific optical signal having wavelength λ1 and the other wavelength-multiplexes optical signals input from other drop wavelength selection/input units 31, to optical amplifier 34-1. Optical amplifier 34-1 amplifies the input optical signal and inputs the amplified optical signal to second WSS 35-1. Second WSS 35-1 inputs the wavelength-specific optical signal having wavelength λ1 from the input optical signal to drop matrix switch 32. Drop matrix switch 32 outputs the input wavelength-specific optical signal from the output port thereof which is connected to first transponder 51-1.

Second WSS 33-2 passes an optical signal including at least the wavelength-specific optical signal having wavelength λ2, from among the wavelength-multiplexed optical signal including the wavelength-specific optical signal having wavelength λ2 and the other wavelength-multiplexes optical signals input from other drop wavelength selection/input units 31, to optical amplifier 34-2. Optical amplifier 34-2 amplifies the input optical signal and inputs the amplified optical signal to second WSS 35-2. Second WSS 35-2 inputs the wavelength-specific optical signal having wavelength λ2 from the input optical signal to drop matrix switch 32. Drop matrix switch 32 outputs the input wavelength-specific optical signal from the output port thereof which is connected to second transponder 51-2.

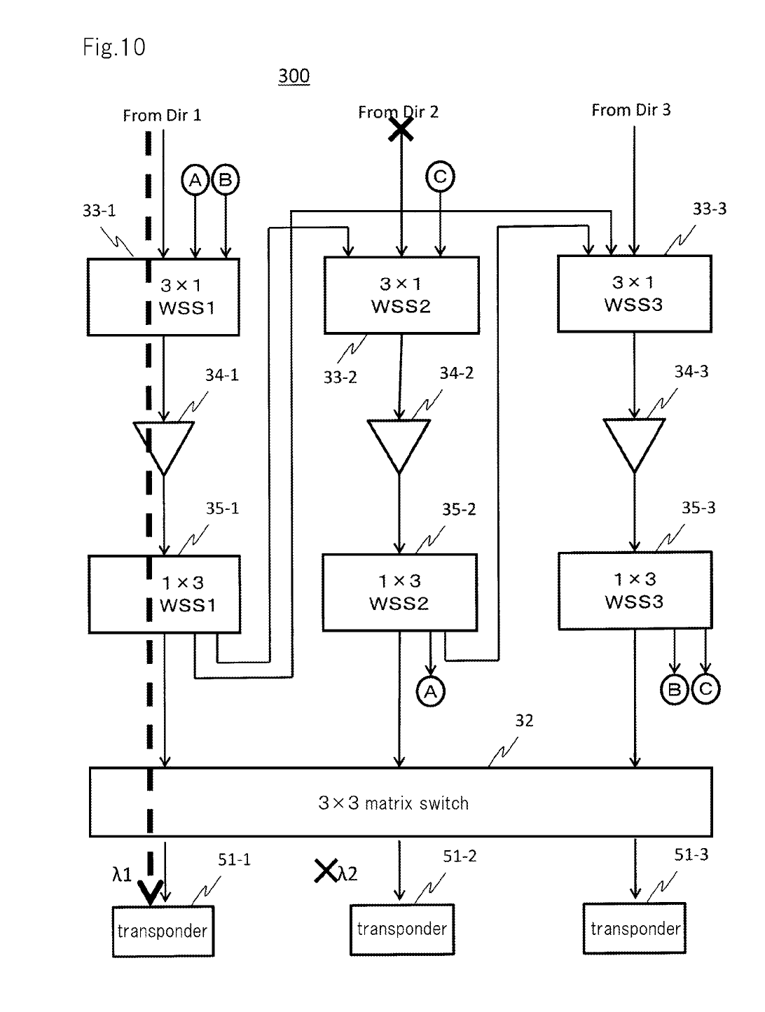

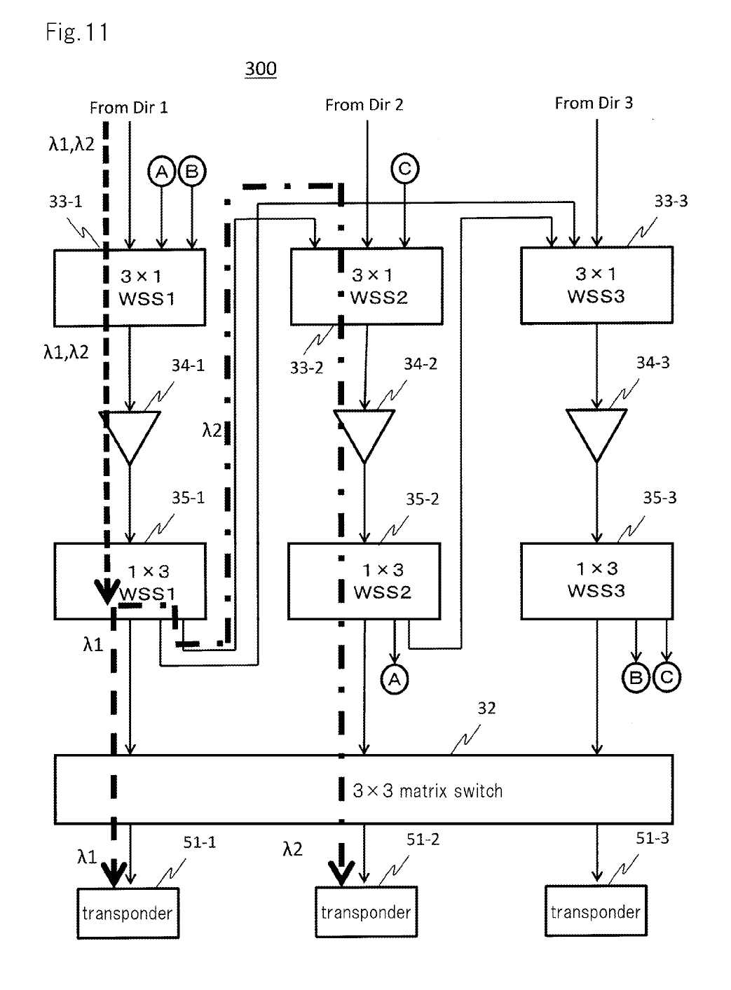

An example of operation of the ROADM system in the case in which a fault occurs in route Dir2 and the wavelength-specific optical signal the has wavelength λ2 is input through route Dir1, bypassing route Dir2, to ROADM node 10A, as shown in FIG. 7, will be described below. FIG. 10 shows in block form the state of the optical dropper when a fault has occurred in the ROADM system according to the present exemplary embodiment. FIG. 11 shows in block form an example of the operation of the ROADM system according to the present exemplary embodiment after the occurrence of the fault.

In the event of the occurrence of a fault in route Dir2 as shown in FIG. 10, first WSS 33-2 is not supplied with the optical signal that includes the wavelength-specific optical signal that has wavelength λ2. At this time, therefore, the wavelength-specific optical signal having wavelength λ2 is not transmitted to second transponder 51-1.

The NMS changes the settings of demultiplexer 11-1 corresponding to route Dir1 and issues a command to cause demultiplexer 11-1 to input a wavelength-multiplexed optical signal including wavelength-specific optical signals having wavelengths λ1, λ2 to first WSS 33-1, as shown in FIG. 11. The NMS also changes the settings of first WSS 33-1 and issues a command to cause first WSS 33-1 to pass the wavelength-specific optical signal having wavelength λ1 and the wavelength-specific optical signal having wavelength λ2 to optical amplifier 34-1. The NMS also changes the settings of second WSS 33-2 and issues a command to cause second WSS 33-2 to pass the wavelength-specific optical signal having wavelength λ1 to drop matrix switch 32 and to input the wavelength-specific optical signal having wavelength λ2 to first WSS 33-2 of second drop wavelength selection/input unit 31-2.

Now, second drop wavelength selection/input unit 31-2 passes, without changing its settings, the wavelength-specific optical signal having wavelength λ2 output from first drop wavelength selection/input unit 31-1 to drop matrix switch 32.

According to the present exemplary embodiment, as described above, optical dropper 300 of ROADM node 10 has drop wavelength selection/input units 31 that corresponds to the respective routes which input wavelength-multiplexed optical signals to ROADM node 10, and drop matrix switches 32 for outputting wavelength-specific optical signals output from drop wavelength selection/input units 31 to different optical paths. With this arrangement, different drop wavelength selection/input units 31 associated with the respective routes receive wavelength-specific optical signals that have been dropped from the wavelength-multiplexed optical signals. Therefore, even when wavelength-specific optical signals that have a common wavelength are input from the respective routes to optical dropper 300, the wavelength-specific optical signals that are input to optical dropper 300 are not mixed together and do not cause conflicts, so that a contentionless function will be realized. Accordingly, it is possible to realize a ROADM system that has CDC functions.

Since drop wavelength selection/input units 31 are connected to one or more drop matrix switches 32 connected to respective transponders, when a new transponder is to be connected to ROADM node 10, it is only necessary to add drop matrix switch 32 which is to be connected to the new transponder. Therefore, any major changes in the system configuration are reduced at the time when a new transponder is to be connected to ROADM node 10, resulting in increased scalability. Accordingly, it is possible to realize a ROADM system with high scalability.

If drop wavelength selection/input units 31 that are associated with the respective routes are simply connected to respective drop matrix switches 32, then in case of the occurrence of a fault, a wavelength-specific optical signal cannot be sent through an alternative path. According to the present exemplary embodiment, an optical signal output from each of drop wavelength selection/input units 31 is input to the other drop wavelength selection/input units 31. Therefore, when a fault has occurred in a route, ROADM node 10 receives a wavelength-specific optical signal having a desired wavelength from a route that is different from the faulty route, and an optical path between client devices connected to transponders can be restored simply when the NMS changes the settings of demultiplexers 11 and drop wavelength selection/input units 31. Accordingly, it is possible to realize a ROADM system with high fault resistance.

According to the present exemplary embodiment, each of drop wavelength selection/input units 31 has first WSS 33 for selecting a wavelength-specific optical signal having a particular wavelength from received wavelength-specific optical signals and outputting the selected wavelength-specific optical signal, and second WSS 35 for outputting the wavelength-specific optical signal output from first WSS 33 to either first output ports connected to drop matrix switches 32 or second output ports connected to other drop wavelength selection/input units 31, depending on the wavelength of the wavelength-specific optical signal. Consequently, the wavelength-specific optical signal having the particular wavelength can reliably be output to a particular optical path.

According to the present exemplary embodiment, an optical amplifier is connected between first WSS 33 and second WSS 35. The optical amplifier increases the strength of the wavelength-specific optical signal to be output, with the result that the wavelength-specific optical signal that has the particular wavelength can more reliably be output to a particular optical path.

According to the present exemplary embodiment, optical adder 400 of the ROADM node has add matrix switches 41 for receiving wavelength-specific optical signals from a plurality of optical paths and outputting the received wavelength-specific optical signals to respective different add wavelength selection/output units 42, and add wavelength selection/output units 42 for taking wavelength-specific optical signals from received optical signals and adding the wavelength-specific optical signals to wavelength-multiplexed optical signals, add wavelength selection/output units 42 corresponding respectively to a plurality of routes for transmitting wavelength-multiplexed optical signals output from ROADM node 10. With this arrangement, different add wavelength selection/input units 42 associated with the respective routes receive wavelength-specific optical signals to be added to wavelength-multiplexed optical signals from respective optical paths. Therefore, even when wavelength-specific optical signals having a common wavelength are input from the respective optical paths, the wavelength-specific optical signals that are input to optical adder 400 are not mixed together and do not cause conflicts, so that a contentionless function will be realized. Accordingly, it is possible to realize a ROADM system having CDC functions.

Since add wavelength selection/input units 42 are connected to one or more drop matrix switches 32 connected to respective transponders, when a new transponder is to be connected to ROADM node 10, it is only necessary to add matrix switch 41 which is to be connected to the new transponder. Therefore, any major changes in the system configuration are reduced at the time when a new transponder is to be connected to ROADM node 10, resulting in increased scalability. Accordingly, it is possible to realize a ROADM system with high scalability.

If add wavelength selection/input units 42 that are associated with the respective routes are simply connected to respective add matrix switches 41, then in case of the occurrence of a fault, a wavelength-specific optical signal cannot be sent through an alternative path. According to the present exemplary embodiment, an optical signal output from each of add wavelength selection/input units 42 is input to the other add wavelength selection/input units 42. Therefore, when a fault has occurred in a route, ROADM node 10 receives a wavelength-specific optical signal having a desired wavelength from a route that is different from the faulty route, and the optical path between client devices connected to transponders can be restored simply when the NMS changes the settings of multiplexers 12 and add wavelength selection/input units 42. Accordingly, it is possible to realize a ROADM system with high fault resistance.

According to the present exemplary embodiment, each of add wavelength selection/input units 42 has third WSS 43 for selecting a wavelength-specific optical signal having a particular wavelength from received wavelength-specific optical signals and outputting the selected wavelength-specific optical signal, and fourth WSS 45 for outputting the wavelength-specific optical signal output from third WSS 43 to either third output ports connected to a corresponding route or fourth output ports connected to other add wavelength selection/input units 42, depending on the wavelength of the wavelength-specific optical signal. Consequently, the wavelength-specific optical signal having the particular wavelength can be reliably output to a particular route.

According to the present exemplary embodiment, an optical amplifier is connected between third WSS 43 and forth WSS 45. The optical amplifier increases the strength of the wavelength-specific optical signal to be output, with the result that the wavelength-specific optical signal having the particular wavelength can more be reliably output to a particular route.

The illustrated configurations according to the exemplary embodiment described above are by way of example only, and the present invention should not be limited to those configurations.

According to the above exemplary embodiment, in ROADM node 10 connected to N routes, each first WSS 33 has N input ports and each drop matrix switch 32 has N input ports and N output ports. However, the present invention is not limited to such an example. The numbers of ports illustrated above are by way of example only, and the switches may have more ports including backup ports which are not in current use. Each second WSS 35 has M output ports where M represents an integer that is equal to or greater than the sum of the number (N−1) of other drop wavelength selection/input units 31 and the number L of connected drop matrix switches.

While preferred embodiments of the present invention have been described using specific terms, such description is for illustrative purposes only, and it is to be understood that changes and variations may be made without departing from the spirit or scope of the following claims.

What is claimed is:

1. An optical signal dropper comprising:
a plurality of drop wavelength selection/input units, each having a first output port and a second output port, for outputting received input wavelength-specific optical signals from the output ports; and
a drop output unit for outputting wavelength-specific optical signals output from the first output ports of the drop wavelength selection/input units, to respective different optical paths;
wherein said drop wavelength selection/input units correspond respectively to a plurality of routes for transmitting wavelength-multiplexed optical signals, and each of said drop wavelength selection/input units receives a wavelength-specific optical signal included in the wavelength-multiplexed optical signal transmitted through a corresponding route and wavelength-specific optical signals output from the second output ports of other drop wavelength selection/input units, as the input wavelength-specific optical signals, and outputs each of the wavelength-specific optical signals from either said first output port or said second output port depending on the wavelength of the wavelength-specific optical signal.

2. The optical signal dropper according to claim 1, wherein each of said drop wavelength selection/input units comprises:
a first wavelength selection switch for selecting a wavelength-specific optical signal having a particular wavelength from the input wavelength-specific optical signals and outputting the selected wavelength-specific optical signal; and
a second wavelength selection switch for outputting the wavelength-specific optical signal output from said first wavelength selection switch to either said first output port or said second output port depending on the wavelength of the wavelength-specific optical signal.

3. The optical signal dropper according to claim 2, wherein each of said drop wavelength selection/input units further comprises:
an optical amplifier for amplifying the wavelength-specific optical signal output from said first wavelength selection switch and outputting the amplified wavelength-specific optical signal to said second wavelength selection switch.

4. The optical signal dropper according to claim 1, comprising a plurality of drop output units as said drop output unit;
wherein each of said drop wavelength selection/input units has a plurality of first output ports as said first output port, said first output ports being connected respectively to said drop output units.

5. An optical signal adder comprising:
a plurality of add wavelength selection/output units which correspond respectively to a plurality of routes for transmitting wavelength-multiplexed optical signals, each of said add wavelength selection/output units having a third output port connected to a corresponding one of the routes and a fourth output port, wherein each of said add wavelength selection/output units outputs received input wavelength-specific optical signals from the output ports; and
an add input unit for receiving wavelength-specific optical signals from a plurality of optical paths and outputting the received wavelength-specific optical signals respectively to said add wavelength selection/output units;
wherein each of said add wavelength selection/output units receives the wavelength-specific optical signals output from said add input unit and the wavelength-specific optical signals output from the fourth output ports of other add wavelength selection/output units, as the input wavelength-specific optical signals, and output each of the wavelength-specific optical signals from either said third output port or said fourth output port depending on the wavelength of the wavelength-specific optical signal.

6. The optical signal adder according to claim 5, wherein each of said add wavelength selection/output units comprises:
a third wavelength selection switch for selecting a wavelength-specific optical signal having a particular wavelength from the wavelength-specific optical signals and outputting the selected wavelength-specific optical signal; and
a fourth wavelength selection switch for outputting the wavelength-specific optical signal output from said third wavelength selection switch to either said third output port or said fourth output port depending on the wavelength of the wavelength-specific optical signal.

7. The optical signal adder according to claim 6, wherein each of said add wavelength selection/output units further comprises:
an optical amplifier for amplifying the wavelength-specific optical signal output from said third wavelength selection switch and outputting the amplified wavelength-specific optical signal to said fourth wavelength selection switch.

8. The optical signal adder according to claim 5, comprising a plurality of add output units as said add output unit;
wherein each of said add wavelength selection/input units has a plurality of input ports, said input ports being connected respectively to said add output units.
